(19) United States
(12) Patent Application Publication
(10) Pub. No.: US 2001/0015028 A1
(43) Pub. Date: Aug. 23, 2001

(54) Power hook - force flies and lures

(76) Inventor: Glenn W. Palmway-Riley, Cow Bay (AU)

Correspondence Address: G.W. PALMWAY-RILEY, c/o L. CROUT, 613 CALIOPE WAY, MT AIRY, MD, 21771, US

(21) Appl. No.: 09/776,147

(22) Filed: Feb. 5, 2001

(30) Foreign Application Priority Data
Feb. 22, 2000 (AU) PQ 5745

(51) Int. Cl. A01K 83/00

(52) U.S. Cl. 43/43.16

(57) ABSTRACT

The Power Hook, Force Flies and Lures invention and its application is disclosed. The power hook is a conductive fish hook wherein the electromagnetic field about the said hook is charged by addition of a conductive winding which is insulated from the said hook. The power hook improvement can be applied to all styles of fishing hooks to suit all styles of fishing, such as, but not limited to, fly fishing, lure fishing or bait fishing. The invention can embody a fishing lure with similar electromagnetic enhancement with attached hook or hooks.

### CROSS-REFERENCE TO RELATED APPLICATIONS

Provisional application; Australia No. PQ5745 filed Feb. 22, 2000.

### STATEMENT REGARDING FEDERALLY SPONSORED

“Not Applicable”

### REFERENCE TO A MICROFICHE APPENDIX

“Not Applicable”

### BACKGROUND OF THE INVENTION

This invention relates to improving the traditional fish hook to make the said fish hook attractive to fish through the generation of an enhanced electromagnetic field and to a lure body of similar construction.

This invention improves upon the traditional inanimate fish hook and simplifies the complex apparatus of traditional electromagnetic generating fishing lures such as described in the U.S. Pat. No. 5,175,950.

### SUMMARY OF THE INVENTION

The invention consists of, in one embodiment, a conductive fish hook with a conductive winding which is both insulated from the said fish hook, and exposed to the water.

The invention consists of, in another embodiment, a fishing lure of similar characteristics.

Impure water (such as sea water) acts as an electrolyte to generate differential charges in the two dissimilar conductors (i.e. the fish hook and the winding). The two conductors generate an electromagnetic field which can be attractive to fish.

The power hook improvement can apply to all variety of conductive fish hooks, insulating layers, and conductive windings to be applied as appropriate, such as, but not limited to, multiple hooks on lures, single hooks for ‘force’ flies and dead baits, or to give live bait extra appeal.

### BRIEF DESCRIPTION OF THE DRAWING

FIG. 1 is a perspective view of one example of a fish hook embodying the invention.

### DETAILED DESCRIPON OF THE INVENTION

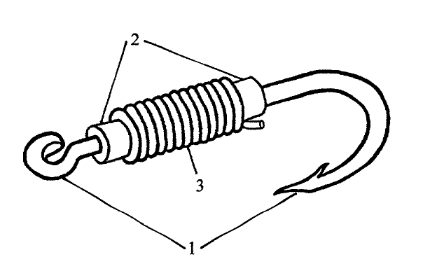

Referring to FIG. 1, it can be seen that the improved fish hook according to this invention comprises a metallic and/or conductive fishing hook (1), an insulating layer (2), and a conductive winding (3). The hook becomes further powered when immersed in impure water.

It will be realized that the improvements according to this invention are not restricted to the simplified example as shown in FIG. 1. This simplified example can be adapted to a variety of materials and mode of manufacture to suit angling style or desired field generation, such as, but not limited to, the hook's (1) composition or inherent magnetism, the insulation layer's (2) design or dimension as to affect flotation or permeability, or the conductive winding's (3) modification to vary weight or the type or intensity of field generated, as in multiple windings or rotating coils to generate complex fields.

In another embodiment of the invention the invention is a fishing lure wherein the fish hook (1) can be substituted with a conductive core with means to attach a fish hook of preferred selection.

I claim that the power hook, force flies and lures consists of:

1. An electromagnetic field generating fish hook comprising;
a) a conductive fish hook;
b) an insulating layer;
c) a conductive winding.

2. The improved fish hook of claim 1 wherein the conductive fish hook component of the invention is modified to vary or enhance the generated electromagnetic field.

3. The improved fish hook of claim 1 wherein the insulating layer component of the invention is modified to vary or enhance the generated electromagnetic field.

4. The improved fish hook of claim 1 wherein the conductive winding component of the invention is modified to vary or enhance the generated electromagnetic field.

5. An electromagnetic field generating fishing fly comprising the improved fish hook of claim 1.

6. An electromagnetic field generating fishing lure comprising;
a) a conductive core;
b) an insulating layer;
c) a conductive winding.

7. The improved fish lure of claim 6 wherein the conductive core component of the invention is modified to vary or enhance the generated electromagnetic field.

8. The improved fish lure of claim 6 wherein the insulating layer component of the invention is modified to vary or enhance the generated electromagnetic field.

9. The improved fish lure of claim 6 wherein the conductive winding component of the invention is modified to vary or enhance the generated electromagnetic field.

10. An improved hook, fly or lure substantially as herein described with reference to the accompanying drawing.
